(19) United States
(12) Patent Application Publication
(10) Pub. No.: US 2004/0171411 A1
(43) Pub. Date: Sep. 2, 2004

(54) Electronic apparatus

(75) Inventors: Yuji Shimoda, Kawasaki (JP); Takao Namiki, Kawasaki (JP)

Correspondence Address: STAAS & HALSEY LLP, SUITE 700, 1201 NEW YORK AVENUE, N.W., WASHINGTON, DC, 20005, US

(73) Assignees: FUJITSU LIMITED, Kawasaki-shi (JP); FUJITSU FRONTECH LIMITED, Tokyo (JP)

(21) Appl. No.: 10/763,300

(22) Filed: Jan. 26, 2004

(30) Foreign Application Priority Data
Feb. 28, 2003 (JP) 2003-052356

(51) Int. Cl. H04M 1/00

(52) U.S. Cl. 455/575.1

(57) ABSTRACT

An electronic apparatus electrically connectable to an external member includes a housing that has an insertion opening, which the external member is inserted into and ejected from, an ejector which is provided movably on the housing, has a movable end that projects from the insertion opening, and projects the external member from the insertion opening as the movable end moves apart from the insertion opening, and a cover, attachable to the housing, which closes the insertion opening.

This application claims the right of priority under 35 U.S.C. §119 based on Japanese Patent Application No. 2003-052356, filed on Feb. 28, 2003, which is hereby incorporated by reference herein in its entirety as if fully set forth herein.

### BACKGROUND OF THE INVENTION

The present invention relates generally to an electronic apparatus, and more particularly to a guide mechanism in a function expansion member that expands a function of the electronic apparatus. The present invention is suitable, for example, for a mechanism that ejects from a housing of a portable information terminal a card type medium, such as a Compact Flash (“CF”) card, a Personal Computer Memory Card International Association (“PCMCIA”) card, and a Secure Digital (“SD”) card.

Nevertheless, the present invention does not limit the function expansion member to be guided by the guide mechanism to the card type medium, but is broadly applicable to peripherals including recording carriers having other shapes, such as a stick type, non-recording carriers, such as a connector at a printer or a digital camera. The inventive electronic apparatus is broadly applicable to mobile communication terminals, such as a personal information terminal for a distribution field, a cell phone, and a personal handy phone, a personal computer (“PC”), and a personal digital assistant (“PDA”).

Recent electronic apparatuses, such as a portable information terminal, have increasingly been required to be small, thin and lightweight for convenient portability, as well as versatile so as not to carry plural apparatuses. For example, portable information terminals have been known in the distribution field for sending and receiving of logistics collection and distribution information, storehouse's storage and retrieval managements, stocktaking, inspections, and store's stocktaking and ordering. This portable information terminal has been made multifunctional to serve as a scanner, a printer, and a barcode reader. More recently, the portable information terminal is required to have improved operability and durability for use with various environments.

The above portable information terminals have conventionally used CF cards as a backup external recording carrier. The CF card is a small memory card derived from a PC card, and transfers information in the portable information terminal to a PC for managements.

In general, there have been known various methods for unloading a card type medium from a terminal, such as a mechanism that uses an eject button, a mechanism that does not completely accommodate a card in a terminal's housing to allow the card to be held and pulled out of the housing, a mechanism that allows the card to be pulled out through a tape tab attached to the card, and a push-push mechanism that loads a card into the terminal through one push of the card and partially ejects the card from the terminal through another push of the card.

Preferable methods will be partial exposure of a card and use of a tab, since the eject-button and the push-push mechanisms would make the terminal's structure complex and result in a large, heavy and expensive apparatus due to the increased number of components.

FIGS. 7 and 8 show portable information terminals 10 and 10A of a tab method. A tab 32 made of a tape-shaped film has been stuck to a CF card 30. Here, FIG. 7 is a perspective view of the portable information terminal 10, which the CF card 30 can be inserted into and ejected from a right side 13 of a housing 12. FIG. 8 is a perspective view of the portable information terminal 10A, which the CF card 30A can be inserted into and ejected from a rear surface 14A of a housing 12A. Tabs 32 and 32A are sold together with the CF cards 30 and 30A while attached to the CF cards 30 and 30A. In inserting the CF card 30 or 30A, a user folds the tab 32 or 32A on the CF card 30 or 30A so that the tab does not expose to the outside, pushes the CF card 30 or 30A into the housing through an insertion opening 16 or 16A, and attaches a CF card cover 34 or 34A. In ejecting the CF card 30 or 30A from the housing 12 or 12A, the user detaches the CF card cover 34 or 34A, unfolds the tab 32 or 32A from the insertion opening 16 or 16A using a tweezers, etc., and takes out the CF card through the tab 32 or 32A. FIGS. 7 and 8 show the tabs 32 and 32A pulled out from the insertion openings 16 and 16A.

The partial exposure method, however, cannot attach the CF card cover, since the card partially exposes from the housing. The portable information terminal should be used sometimes in the rain, and thus needs durability, in particular, water resistance. The partial exposure method has disadvantageously bad water resistance. In addition, it disadvantageously has a danger of card's falling off from the housing and a deletion of stored information.

On the other hand, the tab method that uses the CF card covers 34 and 34A has better water resistance and safety that prevents falling off of the cards 30 and 30A than the partial exposure method. However, a user should unfold the tab 32 or 32A from the insertion opening 16 or 16A in attempts to eject the CF card 30 or 30A, and should fold the tab 32 or 32A from the insertion opening 16 or 16A in mounting the CF card cover 34 or 34A above the tab 32 or 32A. The tabs 32 and 32A are made of a thin film, and a user has a difficulty in forcing to the tab to electrically disconnect a connector (not shown) of the CF card 30 or 30A from the portable information terminal 100 or 100A. As a consequence, the tab method disadvantageously has bad operability in folding, unfolding and pulling out the tab. In addition, the CF card cover 34 or 34A detached from the housing 12 or 12A often gets lost. In addition, the mounted CF card covers 34 and 34A bend the tabs 32 and 32A. Thus, frequent cover mounting would possibly damage the tab, and this method disadvantageously has bad durability. When a manufacturer manufactures and sells the CF card 30 or 30A together with tab 32 or 32A, a user is uneconomically deprived of a chance to select a mass-produced CF card.

### BRIEF SUMMARY OF THE INVENTION

Accordingly, it is an exemplified object of the present invention to provide an electronic apparatus that has at least one of improved operability, durability and economical efficiency.

In order to achieve the above object, an electronic apparatus of one aspect according to the present invention electrically connectable to an external member includes a housing that has an insertion opening, which the external member is to be inserted into and ejected from, an ejector, which is provided movably on the housing, has a movable end that projects from the insertion opening, and projects the external member from the insertion opening as the movable end moves apart from the insertion opening, and a cover, attachable to the housing, which closes the insertion opening. This electronic apparatus uses the cover to maintain environmental resistance (such as waterproof and dustproof), and the ejector projecting from the insertion opening to improve the operability. This electronic apparatus has improved economy since a user can select a mass-produced external member instead of purchasing a dedicated external member, to which the ejector has been already attached. The external member is, for example, a function expansion member that expands a function of the electronic apparatus, such as a CF card.

The ejector may be made of a band member, such as a PET film and a nylon ribbon. Such a band or strip member has a small thickness that enables the thickness of the insertion opening to be approximately equal to that of the external member, maintaining the electronic apparatus thin. The ejector may be made of a transparent material. This structure makes information on the substrate readable through the ejector, when the ejector is fixed onto the substrate connected to the external member, as well as increasing the degree of freedom of an attachment of the ejector. The ejector may be folded so as to hold the external member. Thereby, the ejector may be made, for example, of one foldable sheet material, and have the smaller number of components than one that has a first member that presses an end of the external member, and the second sheet member connected to the first member. Preferably, the ejector has approximately the same width as the external member, because it can serve to guide the external member.

Preferably, the ejector exposes a connector of the external member inserted into the insertion opening for an electric connection with the electronic apparatus.

The electronic apparatus may further include a restriction part that restricts a movement of the end of the ejector, thereby preventing the ejector from separating from the housing and getting lost.

The electronic apparatus may further include a guide member that guides the external member, wherein the ejector may be provided on the guide member, and the guide member may be provided in the housing. The ejector may be movably provided on the guide member, and the guide member may be movably provided in the housing. The electronic apparatus may further include a substrate accommodated in the housing and connectable electrically to the external member, and the guide member may be fixed onto the substrate. The substrate, the ejector, the external member, and the guide member may be aligned in this order in a direction orthogonal to an insertion direction of the external member. Thereby, as the ejector moves, the external member is located on the ejector and a user can easily confirm the external member. Alternatively, the electronic apparatus may further include a substrate accommodated in the housing and connectable electrically to the external member, and the ejector may be pasted onto the substrate. Thus, the ejector does not limit its attachment location and attachment method.

The ejector may be folded so as to hold the external member, have a center hole to expose a connector of the external member for a connection with an electronic apparatus, which external member has been inserted into the insertion opening, and the ejector may be fixed onto the guide member apart from the center hole. When the ejector is fixed onto the guide member at the center hole, the ejector may possibly get damaged at the time of ejecting since the stress concentrates on the peripheral of the center hole of the ejector. Preferably, the electronic apparatus may have a connector connectable electrically to the external member; the ejector may be folded so as to hold the external member, and have a center hole that exposes a connector for a connection with the electronic apparatus. In addition, the center hole preferably sets its size so that the folded ejector does not tangle with the connector.

Preferably, the cover is engaged with the end of the ejector. Since the cover is connected with the ejector and the ejector is attached to the housing, the cover never gets lost. Preferably, an engagement force between the cover and the movable end of the ejector is greater than a force to disconnect an electric connection between the external member and the electronic apparatus, so that an action of separating the cover from the housing can eject the external member. Nevertheless, according to the present invention, an engagement force between the cover and the end of the ejector can be smaller than a force to disconnect an electric connection between the external member and the electronic apparatus because, in this case, an action of moving the ejector can eject the external member. For example, the movable end of the ejector includes an engagement part engageable with the cover, and the cover includes a groove engageable with the engagement part, and a rib that positions the engagement part.

Preferably, the movable end is the thickest in the ejector, because this structure facilitates an application of a force to the end of the ejector and improves the operability. The end of the ejector may have a stretchable bellows shape. This structure enables the cover to close the housing even when the end of the ejector projects from the insertion opening. Preferably, the bellows shape serves to insert the external member into the housing.

Other objects and further features of the present invention will become readily apparent from the following description of preferred embodiments with reference to the accompanying drawings.

### BRIEF DESCRIPTION OF THE DRAWINGS

FIG. 1 is a schematic perspective view of a portable information terminal of a first embodiment according to the present invention without a CF card cover.

FIG. 2 is a schematic sectional view of the portable information terminal shown in FIG. 1 with the CF card cover.

FIG. 3 is a perspective view of an internal structure of the portable information terminal shown in FIG. 1 and its partial enlarged view.

FIG. 4 is a perspective view of a film for an ejector mechanism in the portable information terminal shown in FIG. 1.

FIG. 5 is a perspective view showing a relationship among the film, a CF guide and a substrate shown in FIG. 4.

FIG. 6 is a rear view of the CF card cover shown in FIG. 2.

FIG. 7 is a schematic perspective view of a portable information terminal that uses a tab method as one example of a conventional ejector mechanism of a CF card.

FIG. 8 is a schematic perspective view of a portable information terminal that uses a tab method as another example of a conventional ejector mechanism of the CF card.

### DETAILED DESCRIPTION OF THE PREFERRED EMBODIMENTS

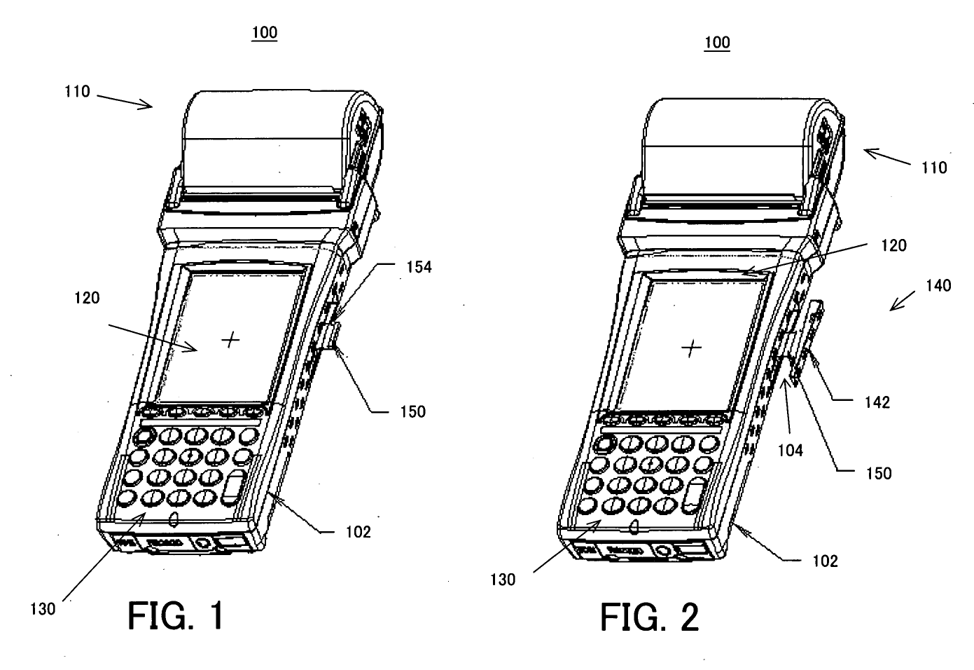

A description will be given of an electronic apparatus of one embodiment according to the present invention, with reference to the accompanying drawings. The instant embodiment uses a portable information terminal (“PIT”) 100 for use with a distribution field as one example of the electronic apparatus. Here, FIGS. 1 and 2 are schematic perspective views of the PIT 100, wherein a CF card cover 142 is removed in FIG. 1 and attached in FIG. 2.

The PIT 100 is applicable broadly to distribution fields, such as distribution industry's ordering, stocktaking, inspections, root sales managements, manufacturing industry's process managements, municipality's inspections of electricity and gas meters, and financial institution's liaison's supports. The PIT 100 can be connected to cell phones and other various networks, such as a LAN and a WAN, for network communications. The PIT 100 operates on a PC-compatible OS, and transfers information through a CF card 50 to a PC for managements. The CF card 50 can be inserted into and ejected from a housing 102 through an insertion opening 104 of the housing 102, which will be described later, and is connectable electrically to the substrate 106.

The PIT 100 includes the housing 102 that has the insertion opening 104 through which the CF card 50 can be inserted into and ejected from the housing 102, the substrate 106, a printer part 110, a display part 120, an operation part 130, and an ejector mechanism 140.

The printer part 110 prints information input through the operation part 130, and information input through an external recording carrier and a network. It adopts an easy loading mechanism to simplify paper exchanges, and serves, for example, as a high-speed printer of maximum 24 lines/sec using a thermal line dot method.

The display part 120 is made, for example, of an LCD, and indicates information input through the operation part 130, and information input through the external recording carrier and the network. The display part 120 also enables user's manual inputs.

The operation part 130 contains, for example, a touch panel, a ten-key, function keys, a power switch, and a reset switch. These components may use any technology known in the art, and a description thereof will be omitted.

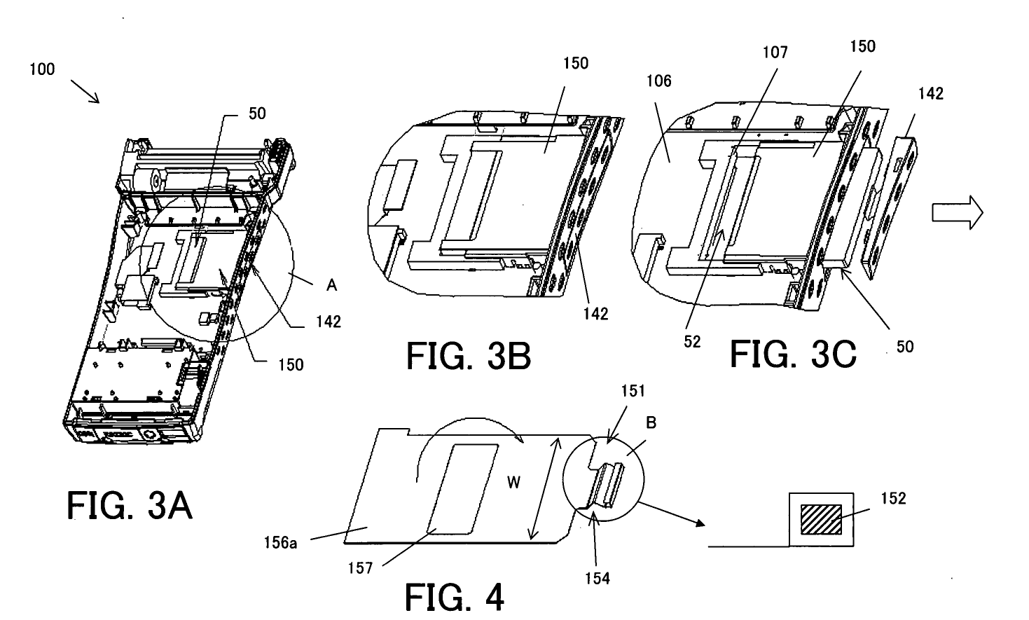

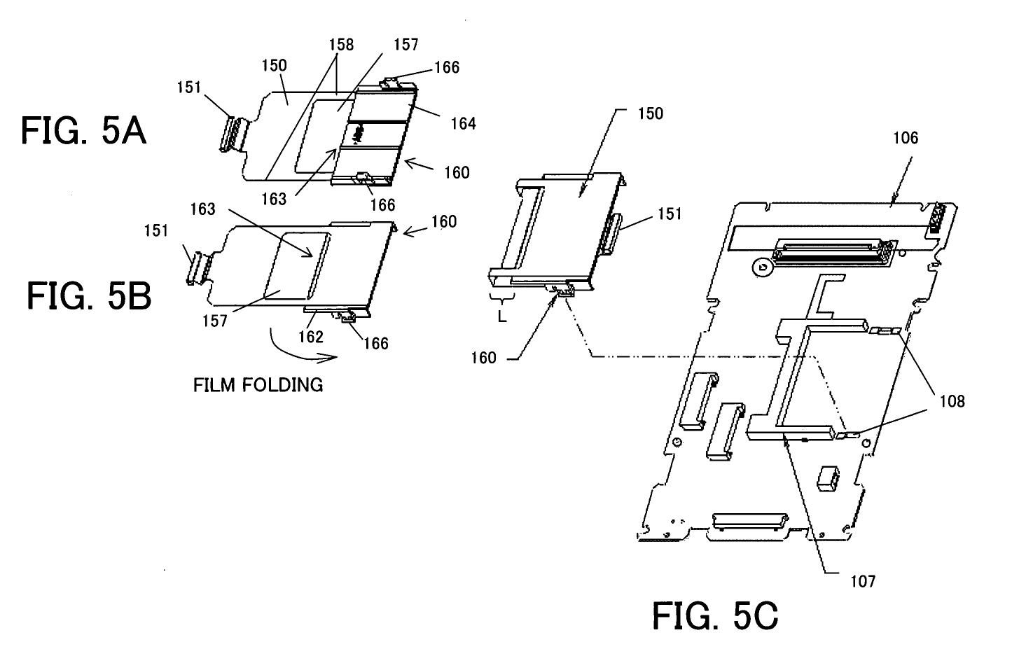

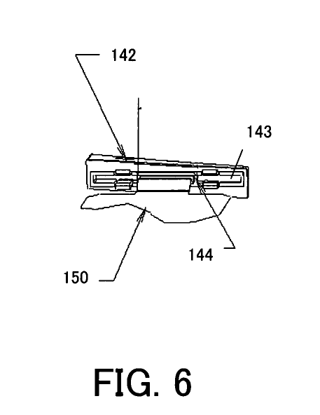

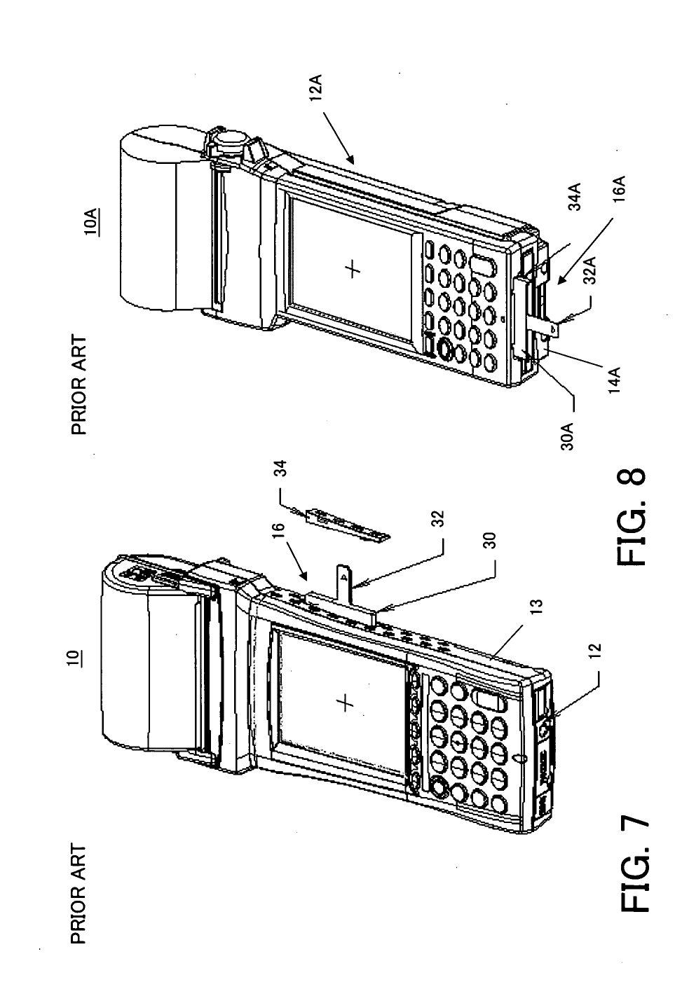

The ejector mechanism 140 ejects the CF card 50. Referring now to FIGS. 3 to 6, a description will be given of the ejector mechanism 140. Here, FIG. 3A is a perspective view of the internal structure of the PIT 100. FIGS. 3B and 3C are partial enlarged views of an area A in FIG. 3A, wherein the CF card is loaded in FIG. 3B and being ejected in FIG. 3C. FIG. 4 is a schematic perspective view of a film. FIGS. 5A and 5B are top and rear views of the film attached to a CF guide, and FIG. 5C is a perspective view showing an attachment of the film-stuck CF guide to the substrate. FIG. 6 is a rear view of a CF card cover. The ejector mechanism 140 includes a CF card cover 142, a film 150, and a CF guide 160.

The CF card cover 142 is attached to the housing 102 and closes the insertion opening 104. The cover 142 secures PIT 100's environmental resistance, such as waterproof and dustproof.

The instant embodiment engages the cover 142 with an end 152 of the film 150. More specifically, the cover 142 has, as shown in FIG. 6, a groove 143 and a pair of ribs 144. The groove 143 is a hole engageable with an engagement part 151 of the film 150, which will be described later, while the ribs 144 position the engagement part 151. Since the cover 142 is connected to the film 150 and the film 150 is fixed inside the housing 102, the cover 142 is prevented from getting lost.

The engagement force between the cover 142 and the engagement part 151 of the film 150 is greater than the binding force between the CF card 50 and a connector 107 of the substrate 106. Thereby, a separating action of the cover 142 from the housing 102 can eject the CF card 50. Of course, the present invention is applicable even when the engagement force between the cover 142 and the engagement part 151 of the film 150 is smaller than the binding force between the CF card 50 and the connector 107 because, in this case, an action of moving the engagement part 151 of the film 150 can eject the CF card 50.

The film 150 is attached movably to the housing 102, and serves to press the CF card 50 in an ejecting direction at the time of ejection. Thus, different from the conventional tab method, the housing 102 has the ejector that ejects the CF card 50. As a result, the economic efficiency improves since a user can select and purchase a mass-produced CF card 50 instead of purchasing a dedicated CF card 30 to which the tab 32 has already been attached.

The instant embodiment makes the film 150 of PET, but can use another material, such as a nylon ribbon, if the material has good elasticity. Such a band material has a small thickness that enables the thickness of the insertion opening 104 to be approximately equal to that of the CF card 50, maintaining the PIT 100 thin.

The film 150 can be made of a transparent material. This structure makes information on the substrate 106 readable through the film 150, such as a substrate's lot number, manufacturer, and characteristics, when the CF card 50 is electrically connected to the substrate 106, which will be described later. This structure also increases the degree of freedom of attachments of the film 150, such as direct pasting on the substrate 106.

The film 150 is made, as shown in FIG. 4, of a sheet material, and has the engagement part 151, a bellows part 154, a base 156, and a center hole 157.

The engagement part 151 is a movable end of the film 150, and projects from the insertion opening 104. The engagement part 151 serves to project the CF card 50 from the insertion opening 104 as it moves apart from the insertion opening 104. Since it has already projected from the insertion opening 104, a user does not have to take it out using a tweezers as in the conventional tab method and the operability improves.

The engagement part 151 is inserted into the groove 143 in the CF card cover 142, and the thickest in the film 150. This structure facilitates an application of an ejecting force to the engagement part 151 of the film 150, improving the operability at the time of ejection. More specifically, as shown in an enlarged plane view of an area B in FIG. 4, the engagement part 151 has such a shape as wraps a prism shaft 152 made of ABS resin.

The bellows part 154 is provided between the stretchable engagement part 151 and the base 156. Even when the engagement part 151 of the film 150 projects from the insertion opening 104, the bellows part 154 folds the projection part and enables the cover 142 to be attached to the housing 102 to close it. The bellows part 154 in the instant embodiment serves to insert the CF card 50 into the housing 102.

As shown by an arrow in FIG. 4, the film 150 is folded so as to hold the CF card 50. The film 150 is made of one foldable sheet material, and the ejector has the smaller number of components than one that has a first member to press the end with the connector of the CF card 50, and the second member connected to the first member. Nevertheless, the present invention is not limited to this structure. The first member is made, for example, of metal and plastic materials, and movably provided in the housing 102 and perpendicular to the end with the connector of the CF card 50. The second member has, for example, the film 150 in this embodiment, or a ribbon, band, rod or another shape.

The base 156 has approximately the same width as the CF card 50. This enables the film 150 to serve to guide the CF card 50. The base 156 has a fixing part 156a fixed onto the CF guide 160.

Referring to FIG. 5, the film 150 is fixed onto the CF guide 160. As shown in FIG. 5B, the film 150 fixed onto a top surface 162 of the CF guide 160 through the fixing part 156a is bent towards the bottom surface 164 of the CF guide 160 shown in FIG. 5A or in an arrow direction shown in FIG. 5B. As a result, it has a shape as shown in FIG. 5C.

The center hole 157 exposes the connector of the CF card 50 inserted into the insertion opening 104 for an electric connection with the substrate 106. The center hole 157 sets its size so that the folded film 150 does not tangle with the connector 107 of the substrate.

The film 150 is preferably fixed onto the CF guide 160 at a portion apart from the center hole 157. When the film 150 is fixed onto the CF guide 160 at the center hole 157, the stress concentrates at both ends 158 of the center hole 157 of the film 150 and possibly damages the ejector at the time of ejection.

The CF guide 160 serves to guide an insertion of the CF card 50, and is made, for example, of ABS resin. The CF guide 160 has a top surface 162, a bottom surface 164, and a pair of attachment parts 166. As discussed above, the film 150 is pasted on the top surface 162. The CF card 50 is held between the bottom surface 164 and the film 150. The attachment part 166 engages with an attachment hole 108 provided in the substrate 106. An alternate embodiment fixes the CF guide 160 onto the substrate 106 through a screw and another attachment member. The instant embodiment attaches the film 150 movably to the CF guide 160, but another embodiment attaches the CF guide 160 movably to the housing 102. The instant embodiment fixes the CF guide 160 directly onto the substrate 106, but the film 150 may be directly pasted on the substrate 106 while maintained partially movable. Thus, the present invention does not limit an attached location and method of the film 150.

The CF guide 160 also serves to restrict a movement of the engagement part 151 of the film 150. Thereby, the film 150 is prevented from being separated from the housing 102 and getting lost. In the CF guide 160 in the instant embodiment, the attachment parts 166 and the end 163 shown in FIGS. 5A and 5B serve as a restriction part.

As shown in FIG. 5C, the instant embodiment attaches the CF guide 160 to the substrate 106 so that the film 150 is down and the CF guide 160 is up. As a result, as the engagement part 151 of the film 150 moves in a right direction in FIG. 5C, the CF card 50 is ejected while placed on the film 150. On the other hand, if the film 150 is up, the CF card 50 is ejected as the engagement part 151 moves in an ejecting direction while placed under the film 150. In this structure, a user has a difficulty in viewing the CF card 50 when the film 150 is opaque. Of course, the present invention does not exclude this structure, if the user does not care or the film 150 is transparent.

A description will now be given of an operation of the PIT 100. A user first takes away the cover 142. The CF card 50 is not a dedicated one to which the tab 32 has already been attached, but the user can select a mass-produced CF card 50 cost-efficiently. Even when the CF card cover 142 is detached, the CF card cover 142 is engaged with the engagement part 151 and is not separated from the housing 102. As a result, the CF card cover 142 can be prevented from getting lost.

Next, the user inserts the CF card 50 through the insertion opening 104, and attaches the CF card cover 142 to the housing 102. In the prior art, the user folds 32 the tab 32, inserts the CF card 30 through the insertion opening 16, and confirms a completed connection between the CF card 30 and the substrate, and then attaches the CF card cover 34. On the other hand, the instant embodiment allows the user to attach the CF card cover 142 to the housing 102 without confirming a completed connection between the connector 52 of the CF card 50 and the connector 107 of the substrate 106. The bellows part 154 in the instant embodiment serves to insert the end of the CF card 50, and the insertion opening 106 designs its depth so that the connector 52 of the CF card 50 is properly engaged with the connector 107 of the substrate 106 when the cover 142 is mounted on the housing 102. The user merely attaches the cover 142 to the housing 102 with the improved operability of the insertion of the CF card 50.

The cover 142 has improved environmental resistance, such as water resistance to rain and dustproof, allowing the PIT 100 to be stably used in various environments.

The user operates the PIT 100 to input, output and display predetermined information, and to store necessary information in the CF card 50. Then, in ejecting the CF card 50 to copy the information stored in it to the PC in his/her office, the user detaches the cover 142. As discussed, the cover 142 never gets lost.

Next, the user pulls the cover 142 in the ejecting direction (or an arrow direction in FIG. 3C). Since the engagement force between the cover 142 and the engagement part 151 of the film 150 is set larger than the binding force between the CF card 50 and the connector 107 of the substrate 106, the CF card 50 can be ejected by an action of separating the cover 142 from the housing 102. Conventionally, after the cover 34 is detached from the housing 12, the tab 32 is taken out from the insertion opening 16 by a tweezers etc., and forced by the user. However, the instant embodiment eliminates this operation and improves operability. Moreover, the operability much improves because an application of a force to the cover 142 is much easier than an application of a force to the tab 32. The bellows 154 has been structured so as to be stretchable and improves the durability, whereas the conventional tab 32 wrinkles and does not have high durability due to folding and accommodation conditions.

At the time of ejection, the film 150 moves by a length L shown in FIG. 5C. This movement disconnects the connector 52 of the CF card 50 from the connector 107. The CF card 50 projects by the length L from the insertion opening 104, and the user's necessary force to take out it is smaller than that in the conventional partial exposure method. Therefore, the operability improves.

After the CF card 50 is taken out, the user again closes the housing 102 by mounting the cover 142 onto the housing 102.

Further, the present invention is not limited to these preferred embodiments, and various variations and modifications may be made without departing from the scope of the present invention. For example, the instant embodiment makes an ejector that ejects a CF card of a sheet material, but the present invention does not require the ejector to be made of a sheet material.

Thus, the present invention can provide an electronic apparatus that has at least one of improved operability, durability and economical efficiency.

What is claimed is:

1. An electronic apparatus electrically connectable to an external member, said electronic apparatus comprising:
a housing that has an insertion opening, which the external member is to be inserted into and ejected from;
an ejector, which is provided movably on said housing, has a movable end that projects from the insertion opening, and projects the external member from the insertion opening as the movable end moves apart from the insertion opening; and
a cover, attachable to said housing, which closes the insertion opening.

2. An electronic apparatus according to claim 1, wherein said ejector is made of a film.

3. An electronic apparatus according to claim 2, wherein said ejector is folded so as to hold the external member.

4. An electronic apparatus according to claim 3, wherein said ejector has approximately the same width as the external member.

5. An electronic apparatus according to claim 1, wherein said ejector is made of a transparent material.

6. An electronic apparatus according to claim 1, wherein said ejector is made of a ribbon.

7. An electronic apparatus according to claim 6, wherein said ejector is folded so as to hold the external member.

8. An electronic apparatus according to claim 7, wherein said ejector has approximately the same width as the external member.

9. An electronic apparatus according to claim 1, wherein the external member has a connector for an electric connection with said electronic apparatus, and
wherein said ejector exposes the connector of the external member inserted into the insertion opening for the electric connection between the external member and said electronic apparatus.

10. An electronic apparatus according to claim 1, further comprising a restriction part that restricts a movement of the movable end of said ejector.

11. An electronic apparatus according to claim 1, further comprising a guide member that guides the external member, wherein said ejector is provided on said guide member, and said guide member is provided in said housing.

12. An electronic apparatus according to claim 11, further comprising a substrate accommodated in said housing and connectable electrically to the external member, said guide member being fixed onto said substrate.

13. An electronic apparatus according to claim 12, wherein said substrate, said ejector, the external member, and said guide member are aligned in this order in a direction orthogonal to an insertion direction of the external member.

14. An electronic apparatus according to claim 11, wherein the external member has a connector for an electric connection with said electronic apparatus, and
wherein said ejector is folded so as to hold the external member, has a center hole to expose the connector of the external member, and is fixed onto said guide member apart from the center hole.

15. An electronic apparatus according to claim 1, further comprising a substrate accommodated in said housing and connectible electrically to the external member, wherein the ejector is pasted on said substrate.

16. An electronic apparatus according to claim 1, wherein said cover is engaged with the movable end of said ejector.

17. An electronic apparatus according to claim 16, wherein an engagement force between said cover and the movable end of said ejector is greater than a force to disconnect an electric connection between the external member and said electronic apparatus.

18. An electronic apparatus according to claim 1, wherein the movable end of said ejector includes an engagement part engageable with said cover, and
wherein said cover includes a groove engageable with the engagement part, and a rib that positions the engagement part.

19. An electronic apparatus according to claim 1, wherein the movable end is the thickest in said ejector.

20. An electronic apparatus according to claim 1, wherein the movable end of said ejector has a stretchable bellows shape.
